(19) United States
(12) Patent Application Publication
(10) Pub. No.: US 2012/0001044 A1
(43) Pub. Date: Jan. 5, 2012

(54) Display Tilting Device

(76) Inventor: Su-Man Gwag, Seoul (KR)

(21) Appl. No.: 13/144,868

(22) PCT Filed: Jan. 15, 2011
(86) PCT No.: PCT/KR2010/000252

§ 371 Date: Sep. 20, 2011

(30) Foreign Application Priority Data
Jan. 15, 2009 (KR) 10-2009-003491

(51) Int. Cl. F16M 13/02

(52) U.S. Cl. 248/277.1

(57) ABSTRACT

The present invention relates to a display tilting apparatus, and more specifically, to a display tilting apparatus, in which an eccentric shaft and a rotating shaft are rotatably installed at both ends of upper and lower link members having a symmetrical structure, and a display apparatus mounted on a tilting plate can be tilted by rotating upward and downward using a motor of a small capacity regardless of the weight of the display apparatus through interactions between the upper and lower link members.

The display tilting apparatus for rotating the display apparatus upward and downward according to the present invention comprises: a rotary plate rotating upward and downward centering on one eccentric shaft; an upper link member connected to an upper part of the rotary plate, for rotating the rotary plate; a lower link member connected to a lower part of the rotary plate, for rotating the rotary plate; a tilting plate rotating upward and downward, for mounting the display apparatus, in which the upper link member is connected to an upper part, and the lower link member is connected to a lower part; and a fixing plate for rotatably supporting the eccentric shaft of the rotary plate and an upper fixing shaft and a lower fixing shaft installed in a middle of the upper link member and the lower link member.

### TECHNICAL FIELD

The present invention relates to a display tilting apparatus, and more specifically, to a display tilting apparatus, in which a rotary plate rotating around an eccentric shaft is installed at one end of upper and lower link members which are symmetrical with respect to a horizontal line, and a tilting plate for mounting a display panel is pivotably installed at the other end of the upper and lower link members so as to keep a balanced state, so that a viewing angle of the display panel can be adjusted up and down by rotating the rotary plate clockwise or counterclockwise using a motor of a small capacity.

### BACKGROUND ART

Generally, a display stand is provided with an apparatus for controlling a viewing angle of a display panel by lifting up and down or pivoting left and right, and up and down a display apparatus such as a television or a monitor.

A display tilting apparatus changes a viewing angle of a display panel vertically by pivoting the display apparatus upward and downward. Recently, direction of the display apparatus can be changed as desired by a user using power, and thus it is convenient to use the display apparatus.

Accordingly, a proper power source is needed depending on the weight of the display apparatus in order to change the direction of the display panel using power. For example, since weight of a large-scaled display apparatus such as an LCD or a PDP of 40 inches or more is 40 to 70 Kg, a motor of a large capacity appropriate to the weight should be used in order to rotate the display apparatus. Since a large moment is loaded in the case of the display tilting apparatus, power of a large capacity should be used, and thus there is a limit in the space, and cost of the display tilting apparatus increases as much accordingly.

FIG. 1 is a view showing an example of a display tilting apparatus according to a conventional technique. As shown in the figure, in a conventional display tilting apparatus 400, a shaft 441 of a motor 440 is inserted and placed in a supporting unit installed with supporting assemblies 410, 420, and 430, and a driving gear 450 is attached to the shaft 441. Accordingly, a driven gear 470 is engaged with the driving gear 450 and receives driving power of the motor 440.

That is, if the motor 440 starts to drive, the driving gear 450 is driven, and if the driven gear 470 rotates thereby, a shaft 460 also rotates, and a connecting body 510 combined with the shaft 460 rotates upward and downward. Subsequently, a tilting plate 500 connected to the front end of the connecting body 510 rotates upward and downward, i.e., tilts.

At this point, since the display apparatus mounted on the tilting plate 500 is considerably heavy, it is difficult to tilt the display apparatus upward and downward only using a small motor. Contrarily, if a large motor is used, although it is possible to tilt the display apparatus, utilization of space is lowered, and it is impractical due to the high price.

Accordingly, a coil spring capable of diminishing gravity is used in a conventional technique in order to tilt the heavy display apparatus while using a small motor. An elastic body 481 of a coil spring form is coupled to the shaft 460, and the elastic body 481 passing through a plate 310 is extended to the lower portion. A supporting unit 300 is provided with a fixing body 483, and the lower portion of the elastic body 481 is combined with a ring-shaped lower mounting unit 482 fixed to the fixing body 483.

According to the configuration described above, a tensile power is generated at the elastic body 481 if the shaft 460 rotates forward, and a repulsive power is generated at the elastic body 481 if the shaft 460 rotates backward. Therefore, the elastic body 481 functions as a supporter of the motor 440, and thus the heavy display apparatus can be tilted using the motor 440 of a small capacity.

However, since elasticity of the elastic body 481 changes as time passes by, a tilting angle cannot be accurately adjusted, and the elastic body 481 should be replaced if the elasticity is lowered. Furthermore, since the size of the elastic body should be changed depending on the weight of the display apparatus, elastic bodies of a variety of sizes should be provided depending on the weight of the display apparatus.

### DISCLOSURE OF INVENTION

### Technical Problem

Therefore, the present invention has been made in view of the above problems, and it is an object of the present invention to provide a display tilting apparatus capable of tilting a display apparatus using a small power by diminishing gravity applied to the display apparatus when rotating the display apparatus upward and downward, thereby making it advantageous from the viewpoint of size and cost.

Another object of the present invention is to provide a display tilting apparatus, in which a tilting angle can be accurately adjusted regardless of passage of using time, and parts of the display tilting apparatus do not need to be replaced depending on the weight of a mounted display apparatus.

Still another object of the present invention is to provide a display tilting apparatus capable of diminishing gravity applied to a display apparatus when tilting the display apparatus, using interactions between a tilting plate and a rotary plate installed at both ends of two link members having a symmetrical structure with respect to a horizontal line, without need of an elastic body.

### TECHNICAL SOLUTION

To accomplish the above object, according to one aspect of the present invention, there is provided a display tilting apparatus for rotating a display apparatus upward and downward, the display tilting apparatus comprising: a rotary plate rotating upward and downward centering on one eccentric shaft; an upper link member connected to an upper part of the rotary plate, for rotating the rotary plate; a lower link member connected to a lower part of the rotary plate, for rotating the rotary plate; a tilting plate rotating upward and downward, for mounting the display apparatus, in which the upper link member is connected to an upper part, and the lower link member is connected to a lower part; and a fixing plate for rotatably supporting the eccentric shaft of the rotary plate and an upper fixing shaft and a lower fixing shaft installed in middles of the upper link member and the lower link member.

In the present invention, the upper link member and the lower link member have a symmetrical structure with respect to a horizontal line passing through the eccentric shaft of the rotary plate.

Preferably, the upper link member includes an upper pivoting rod installed at the upper part of the tilting plate toward up-right and an upper link connected to the other end of the upper pivoting rod and installed at the upper part of the rotary plate toward down-right; and the lower link member includes a lower pivoting rod installed at the lower part of the tilting plate toward down-right and a lower link connected to the other end of the lower pivoting rod and installed at the lower part of the rotary plate toward up-right.

In addition, in the present invention, the display tilting apparatus further comprises a driving means for tilting the tilting plate by rotating the rotary plate, between the upper link member and the lower link member.

The driving means includes: a TM nut fixed to the rotary plate; a TM screw shaft of a certain length screw-connected with the TM nut; and a motor for rotating the rotary plate by rotating the TM screw shaft.

Preferably, the display tilting apparatus further comprises a power transmission module for transmitting rotating power of the motor to the TM screw shaft, between a driving shaft of the motor and the TM screw shaft, in which the driving shaft of the motor is perpendicular to the TM screw shaft.

In the present invention, the TM screw shaft is installed to pass through a first crossbar rotatably installed at the rotary plate rotating around the eccentric shaft and a second crossbar rotatably installed at a front end of a supporting rod, in which the supporting rod is fixed to a rear side of the tilting plate in one piece and rotating around the lower fixing shaft rotatably installed at the fixing plate.

According to another aspect of the present invention, there is provided a display tilting apparatus for rotating a display apparatus upward and downward, the display tilting apparatus comprising: two rotary plates rotating upward and downward centering on one eccentric shaft; two upper link members connected to upper parts of the rotary plates, for rotating the rotary plates; two lower link members connected to lower parts of the rotary plates, for rotating the rotary plates; a tilting plate rotating upward and downward, for mounting the display apparatus, in which the two upper link members are connected to upper parts, and the two lower link members are connected to lower parts; and two fixing plates for rotatably supporting the two eccentric shafts formed at the rotary plates and two upper fixing shafts and two lower fixing shafts installed in middles of the upper link members and the lower link members.

In the embodiment, the display tilting apparatus further comprises: a TM nut fixed to a first crossbar rotatably installed between the two rotary plates; a TM screw shaft of a certain length screw-connected with the TM nut and rotatably passing through a second crossbar rotatably installed at front ends of two supporting rods; and a motor fixed to the second crossbar, for rotating the TM screw shaft.

### ADVANTAGEOUS EFFECTS

According to the display tilting apparatus of the present invention, a tilting plate and a rotary plate are rotatably installed at both sides of upper and lower link members which are symmetrical with respect to a horizontal line so as to keep a balanced state, and when the rotary plate rotates upward and downward to adjust a viewing angle, the upper and lower link members rotate the tilting plate in association with each other, and thus a viewing angle of a display panel can be adjusted regardless of the weight of the display apparatus using a motor of a small capacity.

### BRIEF DESCRIPTION OF THE DRAWINGS

FIG. 1 is a perspective view showing an example of a display tilting apparatus according to a conventional technique.

FIGS. 2 and 3 are conceptual views showing a display tilting apparatus according to the present invention, in which FIG. 2 shows a view mounting a fixing plate, and FIG. 3 shows a view dismounting the fixing plate.

FIGS. 4 to 6 are views illustrating an action for arriving at a balanced state between a weight G of a display apparatus and a restoration force F of the display apparatus when the display apparatus having a certain weight is mounted on a tilting plate of a display tilting apparatus according to the present invention.

FIG. 7 is a view schematically showing an example of a driving means of a display tilting apparatus according to the present invention.

FIGS. 8 and 9 are conceptual views showing a tilting action of a display tilting apparatus according to the present invention.

FIG. 10 is a perspective view showing an example of a display stand installed with a display tilting apparatus according to the present invention.

FIG. 11 is a perspective view showing an example of a display tilting apparatus according to the present invention.

FIG. 12 is an exploded perspective view showing the display tilting apparatus shown in FIG. 11.

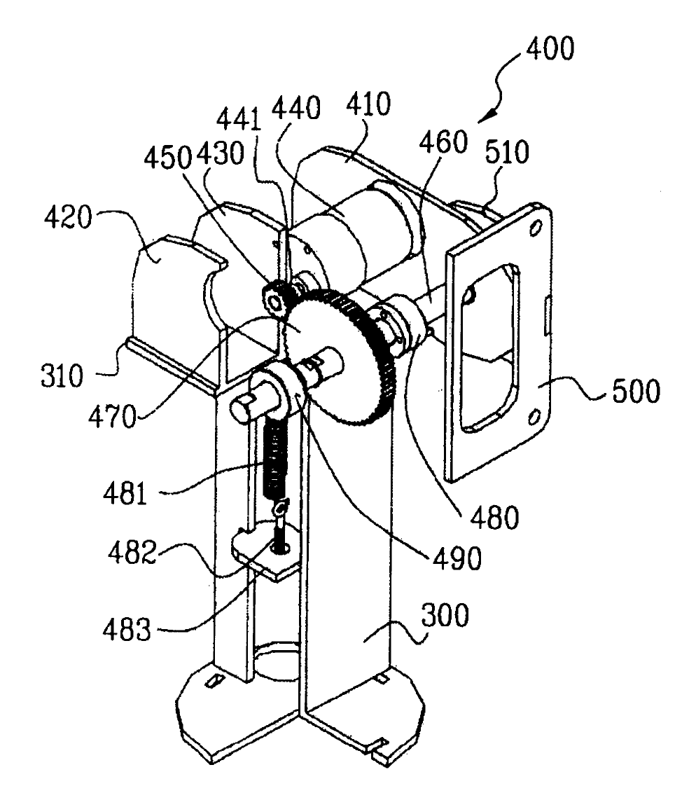

### DESCRIPTION OF SYMBOLS

| 1, 100: Display tilting apparatus | |
|---|---|
| 3: Upper link member | 5: Lower link member |
| 10: Rotary plate | 11: Eccentric shaft |
| 20: Tilting plate | 24: Upper pivoting shaft |
| 26: Lower pivoting shaft | 30: Upper link |
| 33: Upper free rotating shaft | |
| 40: Upper pivoting rod | 44: Upper fixing shaft |
| 50: Lower link | |
| 55: Lower free rotating shaft | |
| 60: Lower pivoting rod | 66: Lower fixing shaft |
| 70: Fixing plate | 80: Pivoting means |
| 81: Supporting rod | 83: First crossbar |
| 86: Second crossbar | 90: Driving means |
| 91: Motor | 93: TM nut |

95: TM screw shaft
97: Power transmission module

### BEST MODE FOR CARRYING OUT THE INVENTION

The preferred embodiments of a display tilting apparatus according to the present invention will be hereafter described in detail, with reference to the accompanying drawings.

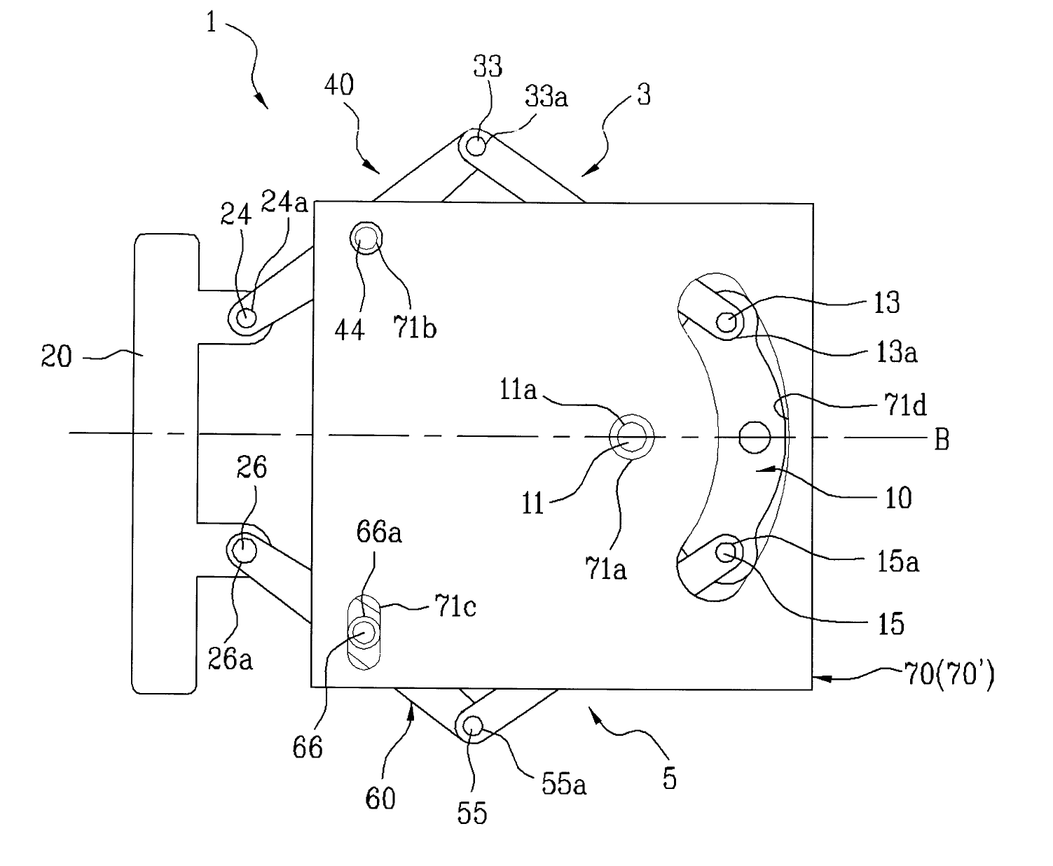

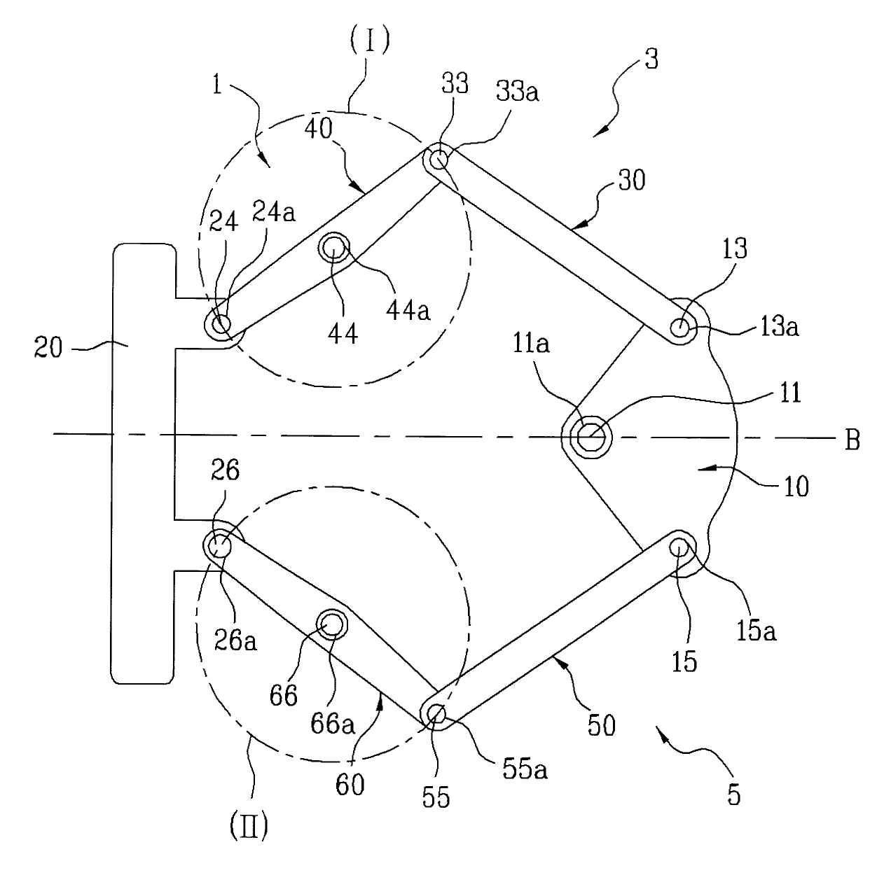

FIGS. 2 and 3 are conceptual views showing a display tilting apparatus according to the present invention, in which FIG. 2 shows a view mounting a fixing plate, and FIG. 3 shows a view dismounting the fixing plate.

First, referring to FIG. 3, the display tilting apparatus 1 according to the present invention comprises a rotary plate 10 rotating around an eccentric shaft 11, an upper link member 3 installed at an upper part of the rotary plate 10 to rotate the rotary plate 10 around the eccentric shaft 11, a lower link member 5 installed at a lower part of the rotary plate 10 to rotate the rotary plate 10 around the eccentric shaft 11, and a tilting plate 20 pivotably installed at the other end of the upper and lower link members 3 and 5.

The tilting plate 20 is supported by the actions of the upper and lower link members 3 and 5 so as to pivot, i.e., tilt.

Referring to FIG. 2, fixing plates 70 and 70′ rotatably fix the rotary plate 10 and the upper and lower link members 3 and 5. The fixing plates 70 and 70′ are installed at both sides with the intervention of the rotary plate 10 and the upper and lower link members 3 and 5. Penetrating holes 71a, 71b, and 71c for installing the eccentric shaft 11 and upper and lower fixing shafts 44 and 66 are formed at the fixing plate 70. In addition, a guiding groove 71d for guiding movement of upper and lower rotating shafts 13 and 15 is further installed at the fixing plate 70.

Referring to FIG. 3, the rotary plate 10 is a metal plate having an eccentric hole 11a formed toward the tilting plate 20, an upper hole 13a formed at an upper part of the rotary plate 10 to be spaced apart from the eccentric hole 11a by a certain distance, and a lower hole 15a formed at a lower part of the rotary plate 10 to be spaced apart from the eccentric hole 11a by a certain distance.

The upper link member 3 comprises an upper link 30 and an upper pivoting rod 40. One end of the upper link 30 is rotatably connected to the upper rotating shaft 13 of the rotary plate 10, and the other end of the upper link 30 is installed to be sloped upward. One end of the upper pivoting rod 40 is connected to an upper free rotating shaft 33 formed at the other end of the upper link 30, and the other end of the upper pivoting rod 40 is installed to be sloped downward and connected to an upper pivoting shaft 24 formed on the rear side of the tilting plate 20. In addition, the upper pivoting rod 40 is installed so as to rotate around the upper fixing shaft 44.

The lower link member 5 comprises a lower link 50 and a lower pivoting rod 60. One end of the lower link 50 is rotatably connected to the lower rotating shaft 15 of the rotary plate 10, and the other end of the lower link 50 is installed to be sloped downward. One end of the lower pivoting rod 60 is connected to a lower free rotating shaft 55 formed at the other end of the lower link 50, and the other end of the lower pivoting rod 60 is installed to be sloped upward and connected to a lower pivoting shaft 26 formed on the rear side of the tilting plate 20. In addition, the lower pivoting rod 60 is installed so as to rotate around the lower fixing shaft 66 rotatably installed at the fixing plate 70.

Accordingly, as shown in FIG. 3, the upper pivoting shaft 24 and the upper free rotating shaft 33 formed at both ends of the upper pivoting rod 40 rotate along rotation trajectory ( [symbol] ) centering on the upper fixing shaft 44. In addition, the lower pivoting shaft 26 and the lower free rotating shaft 55 formed at both ends of the lower pivoting rod 60 rotate along rotation trajectory ( [symbol] ) centering on the lower fixing shaft 66.

The tilting plate 20 tilts depending on the relative positions of the upper and lower pivoting shafts 24 and 26 moving upward, downward, forward, and backward along rotation trajectories (|) and (∥).

The rotary plate 10 rotates around the eccentric shaft 11 depending on the relative positions of the upper and lower links 30 and 50 which are moved by the upper and lower free rotating shafts 33 and 55 rotating upward, downward, forward, and backward along rotation trajectories (|) and (∥).

For example, the upper pivoting rod 40 of the upper link member 3 rotates clockwise or counterclockwise along rotation trajectory (|) centering on the upper fixing shaft 44 fixed to the fixing plate 70. In addition, the lower pivoting rod 60 of the lower link member 5 rotates clockwise or counterclockwise along rotation trajectory (∥) centering on the lower fixing shaft 66 fixed to the fixing plate 70.

If the upper and lower pivoting rods 40 and 60 rotate, the upper free rotating shaft 33 formed at one end of the upper pivoting rod 40 rotates clockwise or counterclockwise along rotation trajectory (|), and the lower free rotating shaft 55 formed at one end of the lower pivoting rod 60 also rotates clockwise or counterclockwise along rotation trajectory (∥).

In addition, if the upper and lower pivoting rods 40 and 60 rotate, the upper pivoting shaft 24 formed at the other end of the upper pivoting rod 40 rotates clockwise or counterclockwise along rotation trajectory (|), and the lower pivoting shaft 26 formed at the other end of the lower pivoting rod 60 also rotates clockwise or counterclockwise along rotation trajectory (∥).

At this point, the upper pivoting rod 40 connected to the upper part of the tilting plate 20 is installed toward up-right, and the lower pivoting rod 60 installed at the lower part of the tilting plate 20 is installed toward down-right. Accordingly, the upper pivoting rod 40 and the lower pivoting rod 60 are horizontally symmetric to each other with respect to line B-B passing through the eccentric shaft 11 of the rotary plate 10 and installed to be open toward the rotary plate 10.

Accordingly, if the upper pivoting rod 40 rotates clockwise centering on the upper fixing shaft 44, the upper pivoting shaft 24 moves up-left, and the upper free rotating shaft 33 moves down-right. In addition, the lower pivoting rod 60 also rotates clockwise centering on the lower fixing shaft 66, and thus the lower pivoting shaft 26 moves up-right, and the lower free rotating shaft 55 moves down-left.

As described above, since the upper and lower pivoting shafts 24 and 26 have different moving directions (left-right) horizontally and the same moving direction (up-up) vertically, the tilting plate 20 smoothly tilts to the left.

On the other hand, the upper link 30 connected to one end of the upper pivoting rod 40 is installed toward down-right, and the lower link 50 connected to one end of the lower pivoting rod 60 is installed toward up-right. Accordingly, the upper and lower links 30 and 50 are horizontally symmetric to each other with respect to line B-B passing through the eccentric shaft 11 of the rotary plate 10 and installed to be open toward the tilting plate 20.

Accordingly, if the upper pivoting rod 40 rotates clockwise centering on the upper fixing shaft 44 and thus the upper free rotating shaft 33 moves down-right along rotation trajectory ( [symbol] ), the upper link 30 moves down-right. Then, the lower free rotating shaft 55 moves down-left, and the lower link 50 moves down-left, and thus the rotary plate 10 and the tilting plate 20 rotate clockwise centering on the eccentric shaft 11.

That is, rotating directions of the upper pivoting rod 40, the lower pivoting rod 60, and the rotary plate 10 are the same, and if the upper and lower pivoting rods 40 and 60 and the rotary plate 10 rotate clockwise, the tilting plate 20 pivots to the left, and if the upper and lower pivoting rods 40 and 60 and the rotary plate 10 rotate counterclockwise, the tilting plate 20 pivots to the right.

As described above, in the display tilting apparatus 1 according to the present invention, if either the tilting plate 20 or the rotary plate 10 installed at one end of the upper and lower link members 3 and 5 rotates, the tilting plate 20 or the rotary plate 10 installed at the other end interacts through the upper and lower link members 3 and 5.

On the other hand, FIG. 3 is a view showing a tilting plate 20 from which a display apparatus is dismounted. In this state, the upper and lower link members 3 and 5 are arranged to be symmetrical with respect to a horizontal line (B-B) passing through the eccentric shaft 11, and the tilting plate 20 is in an upright state without being tilted to the left nor the right.

However, in order to smoothly associate the tilting plate 20 and the rotary plate 10 installed at both ends of the upper and lower link members 3 and 5, the upper and lower link members 3 and 5 should be arranged to be symmetrical with respect to the horizontal line (B-B) passing through the eccentric shaft 11, and the tilting plate 20 should be maintained to be upright, even when a display apparatus 2 of a certain weight is mounted on the tilting plate 20.

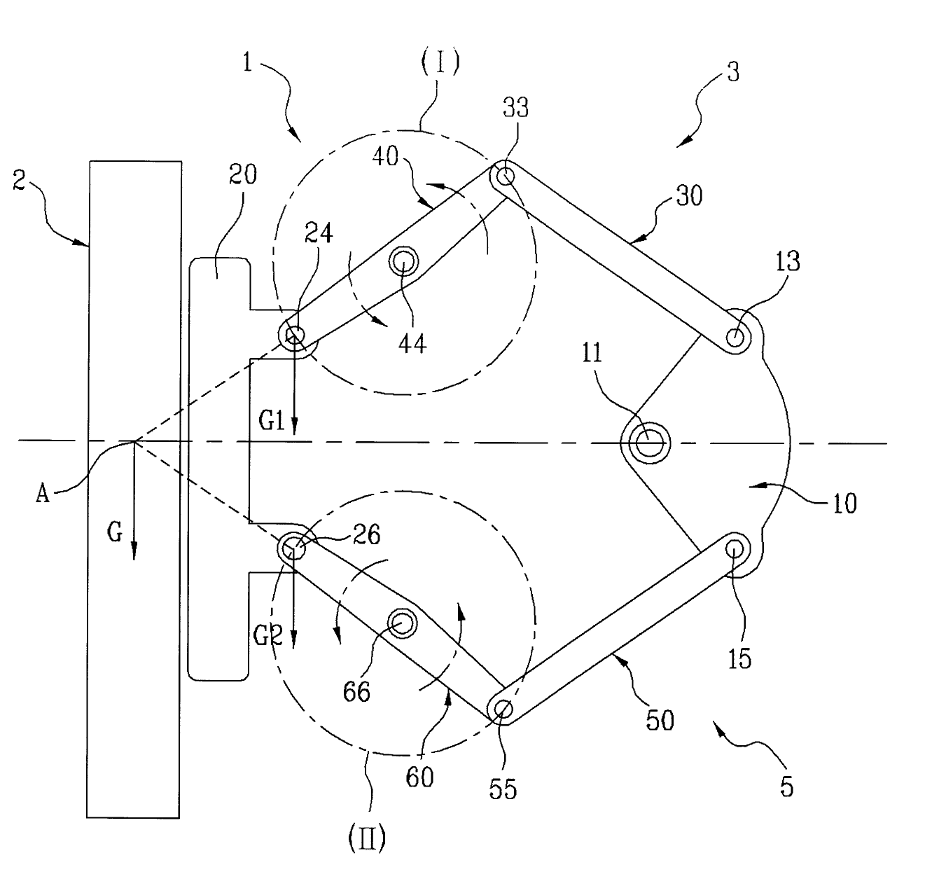

Referring to FIGS. 4 to 6, a balancing action taken when the display apparatus 2 having a certain weight G is mounted on the tilting plate 20 will be described.

First, as shown in FIG. 4, if the display apparatus 2 having a certain weight G is mounted on the tilting plate 20, the load G applied to the center of gravity A is distributed to the upper and lower pivoting shafts 24 and 26 through the tilting plate 20. Then, a distributed load of G1 is applied to the upper pivoting shaft 24, and a distributed load of G2 is applied to the lower pivoting shaft 26.

If the loads G1 and G2 are not yet applied to the upper and lower pivoting shafts 24 and 26, lengthwise directions of the upper and lower pivoting rods 40 and 60, particularly, lengthwise directions passing through the upper and lower fixing shafts 44 and 66, converge on the center of gravity A of the display apparatus 2, and thus the upper and lower pivoting rods 40 and 60 do not rotate. That is, if the lengthwise directions of the upper and lower pivoting rods 40 and 60 correspond to the directions of the dotted lines, rotational moment is not applied to the upper and lower pivoting rods 40 and 60 rotating around the upper and lower fixing shafts 44 and 66, and thus the upper and lower pivoting rods 40 and 60 do not rotate in any direction.

However, as shown in the figure, if the display apparatus 2 having a certain weight G is mounted on the tilting plate 20, distributed loads G1 and G2 are applied to the upper and lower pivoting shafts 24 and 26 of the upper and lower pivoting rods 40 and 60, and the distributed loads G1 and G2 act as a rotational moment on the upper and lower pivoting rods 40 and 60, and thus the upper and lower pivoting rods 40 and 60 rotate counterclockwise centering on the upper and lower fixing shafts 44 and 66.

As described above, if the upper and lower pivoting rods 40 and 60 rotate counterclockwise along rotation trajectories (|) and (∥) by the distributed loads G1 and G2, the rotary plate 10 rotates counterclockwise by the actions of the upper and lower link members 3 and 5. That is, if the upper and lower pivoting rods 40 and 60 rotate counterclockwise, the upper link 30 connected to the upper pivoting rod 40 moves up-left by the upper free rotating shaft 33 moving along trajectory (|). Then, the upper link 30 connected to the upper part of the rotary plate 10 moves up-left, and thus the rotary plate 10 rotates counterclockwise centering on the eccentric shaft 11. At the same time, the lower link 50 connected to the lower pivoting rod 60 moves up-right by the lower free rotating shaft 66 moving along rotation trajectory (∥). Then, the lower link 50 connected to the lower part of the rotary plate 10 moves up-right, and thus the rotary plate 10 rotates counterclockwise centering on the eccentric shaft 11.

As described above, if the display apparatus 2 having a certain weight is mounted on the tilting plate 20, the rotary plate 10 rotates counterclockwise. Subsequently, if the rotary plate 10 rotates counterclockwise, the tilting plate 20 installed at the other end of the upper and lower link members 3 and 5 rotates clockwise. That is, if the rotary plate 10 rotates counterclockwise, the upper link 30 moves up-left and rotates the upper pivoting rod 40 counterclockwise centering on the upper fixing shaft 44, and the lower link 50 moves up-right and rotates the lower pivoting rod 60 counterclockwise centering on the lower fixing shaft 66.

If both the upper and lower pivoting rods 40 and 60 rotate counterclockwise, the upper pivoting shaft 24 connected to the tilting plate 20 rotates along rotation trajectory (|) and moves down-right, and the lower pivoting shaft 26 rotates along rotation trajectory (∥) and moves down-left. Then, the upper part of the tilting plate 20 moves to the right, and the lower part of the tilting plate 20 moves to the left, and thus the tilting plate 20 and the display apparatus 2 installed on the front side of the tilting plate 20 rotate to the right.

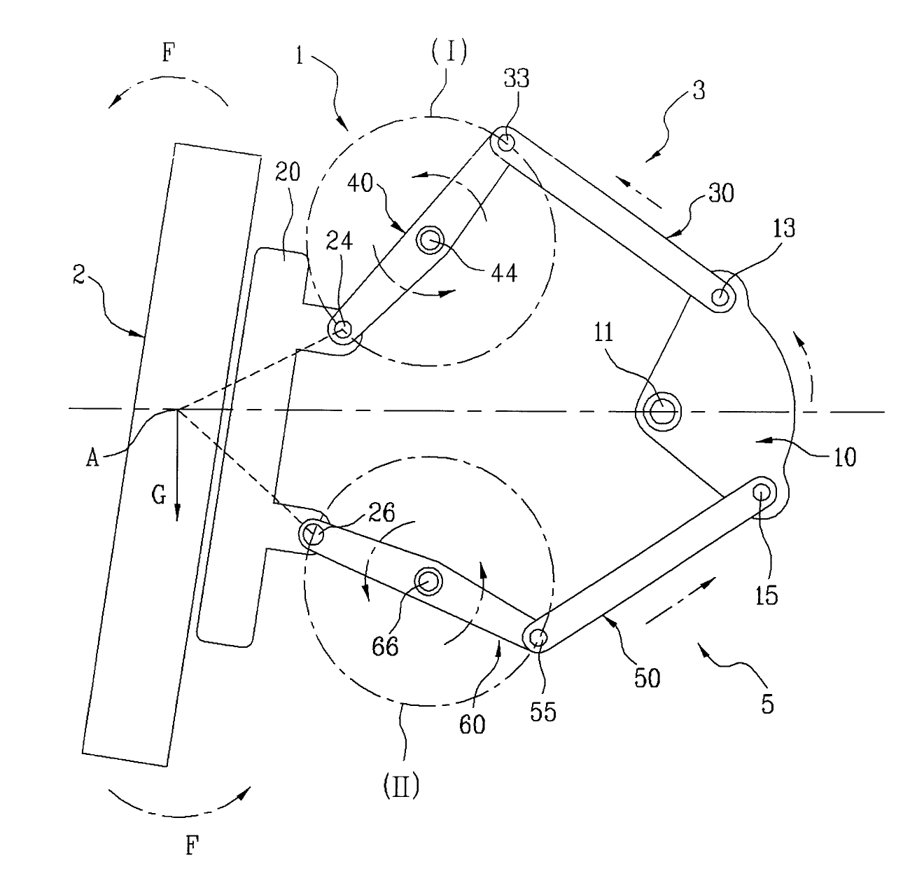

As shown in FIG. 5, if the display apparatus 2 rotates to the right, lengthwise directions of the upper and lower pivoting rods 40 and 60 do not converge on the center of gravity A of the display apparatus 2. That is, the lengthwise directions of the upper and lower pivoting rods 40 and 60 do not correspond to the dotted lines of the tilting plate 20.

If the display apparatus 2 rotates to the right while the lengthwise directions of the upper and lower pivoting rods 40 and 60 do not converge on the center of gravity A of the display apparatus 2, a restoration force F trying to rotate the display apparatus 2 to the left is generated. Then, the restoration force F rotates the upper and lower pivoting rods 40 and 60 clockwise, and the rotary plate 20 installed at one end of the upper and lower link members 3 and 5 rotates clockwise again.

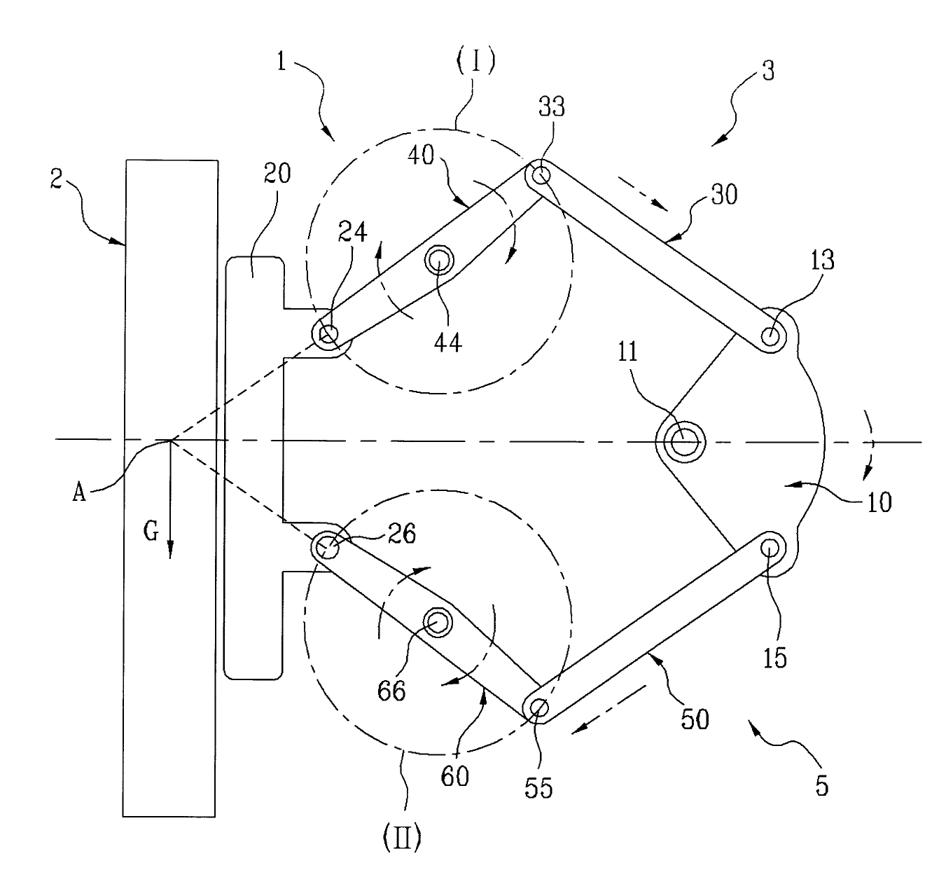

That is, as shown in FIG. 6, if the upper part of the tilting plate 20 moves to the left and the lower part of the tilting plate 20 moves to the right, and thus the tilting plate 20 and the display apparatus 2 installed on the front side of the tilting plate 2 rotate to the left, the upper pivoting shaft 24 connected to the upper part of the tilting plate 20 moves up-left along rotation trajectory (|) and rotates the upper pivoting rod 40 clockwise, and the lower pivoting shaft 26 connected to the lower part of the tilting plate 20 moves up-right along rotation trajectory (∥) and rotates the lower pivoting rod 60 clockwise.

Subsequently, if the upper pivoting rod 40 rotates clockwise, the upper free rotating shaft 33 and the upper link 30 installed at one end of the upper pivoting rod 40 move down-right, and the lower free rotating shaft 55 and the lower link 50 installed at one end of the lower pivoting rod 60 move down-left. As described above, if left and right moving directions of the upper and lower links 30 and 50 are different, the rotary plate 10 rotates clockwise centering on the eccentric shaft 11.

If the rotary plate 10 rotates counterclockwise by the weight G of the display apparatus 2 and then the rotary plate 10 rotates clockwise again by the restoration force F, the moment generated by the weight G of the display apparatus 2 and the moment of the restoration force F offset each other, and thus the lengthwise directions of the upper and lower pivoting rods 40 and correspond to the dotted lines of the tilting plate 20. Therefore, the upper and lower pivoting rods 40 and 60 do not rotate any more and keep a balanced state.

That is, since the display tilting apparatus 1 according to the present invention associates the tilting plate 20 and the rotary plate 10 using the upper and lower link members 3 and 5, the moment of load G generated when the display apparatus 2 of a certain weight is installed on the tilting plate 20 offsets the restoration force F generated when the display apparatus 2 moves to the right in association with the rotary plate 10, and thus a balanced state is maintained. Therefore, it is possible to tilt the display apparatus 2 using only a small force regardless of the weight of the display apparatus 2.

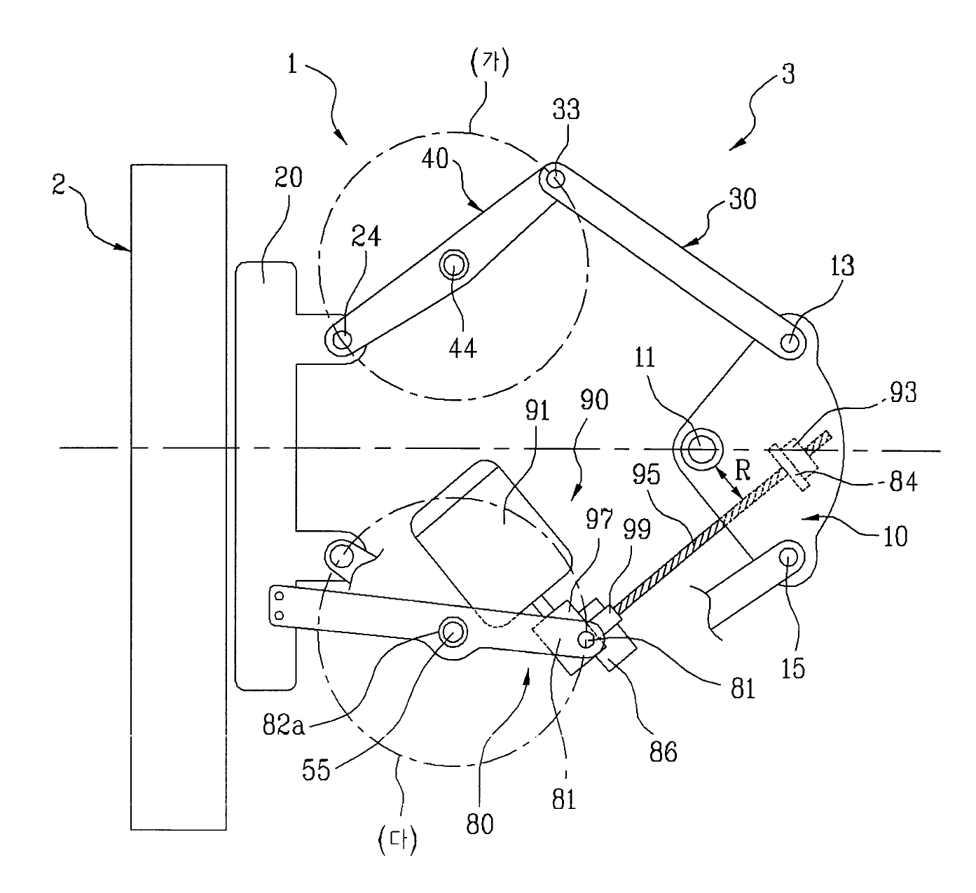

FIG. 7 is a view schematically showing an example of a driving means of a display tilting apparatus according to the present invention. As shown in the figure, a driving means for rotating the rotary plate 10 in one direction should be provided in order to rotate the tilting plate 20 mounted with the display apparatus 2. FIG. 7 shows the configuration of a driving means according to a preferred embodiment.

As shown in the figure, the driving means 90 comprises a TM nut 93 fixed to the rotary plate 10, a TM screw shaft 95 of a certain length screw-connected with the TM nut 93, and a motor 91 for rotating the rotary plate 10 by rotating the TM screw shaft 95.

In addition, a power transmission module 97 for transmitting rotating power of the motor 91 to the TM screw shaft 95 is interposed between the motor 91 and the TM screw shaft 95. The power transmission module 97 transmits the rotating power of a driving shaft of the motor 91 to the TM screw shaft 95 perpendicular to the driving shaft.

The display tilting apparatus 1 of the present invention further comprises a pivoting means 80 for rotating the driving means 90 according to pivoting of the TM nut 93 fixed to the rotary plate 10. The pivoting means 80 smoothly transmits the rotating power of the motor 91 to the TM nut 93 by rotating the TM screw shaft 95 together with the TM nut 93 when the TM nut 93 fixed to the rotary plate 10 rotates together with the rotary plate 10.

The pivoting means 80 includes a first crossbar 84 rotatably fixed to the rotary plate 10 and installed with the TM nut 93 formed in one piece, a second crossbar 86 rotatably installed with the front end of a supporting rod 81 of a certain length, in which the supporting rod 81 is fixed to the rear side of the tilting plate 20 and protrudes toward the rotary plate 10, and the TM screw shaft 95 passing through a penetrating hole formed at the first crossbar 84 and a penetrating hole formed at the second crossbar 86.

The first crossbar 84 is rotatably installed by installing a fixing pin in a penetrating hole formed at the rotary plate 10, and the second crossbar 86 is rotatably installed by installing a fixing pin in a penetrating hole formed at the front end of the supporting rod 81.

In addition, the TM nut 93 is installed at the penetrating hole of the first crossbar 84, and a bearing 99 is installed at the penetrating hole of the second crossbar 86.

In addition, a penetrating hole for passing the lower fixing shaft 66 is formed so that the supporting rod 81 may rotate around the lower fixing shaft 66 of the lower pivoting rod 60 and form rotation trajectory (|∥).

Accordingly, if the motor 91 rotates, the TM screw shaft 95 rotates through the power transmission module 97. If the TM screw shaft 95 rotates in one direction, the TM nut 93 tries to move straightly upward and downward along the TM screw shaft 95. However, since the TM nut 93 is fixed to the rotary plate 10, the TM nut 93 rotates the rotary plate 10 clockwise or counterclockwise.

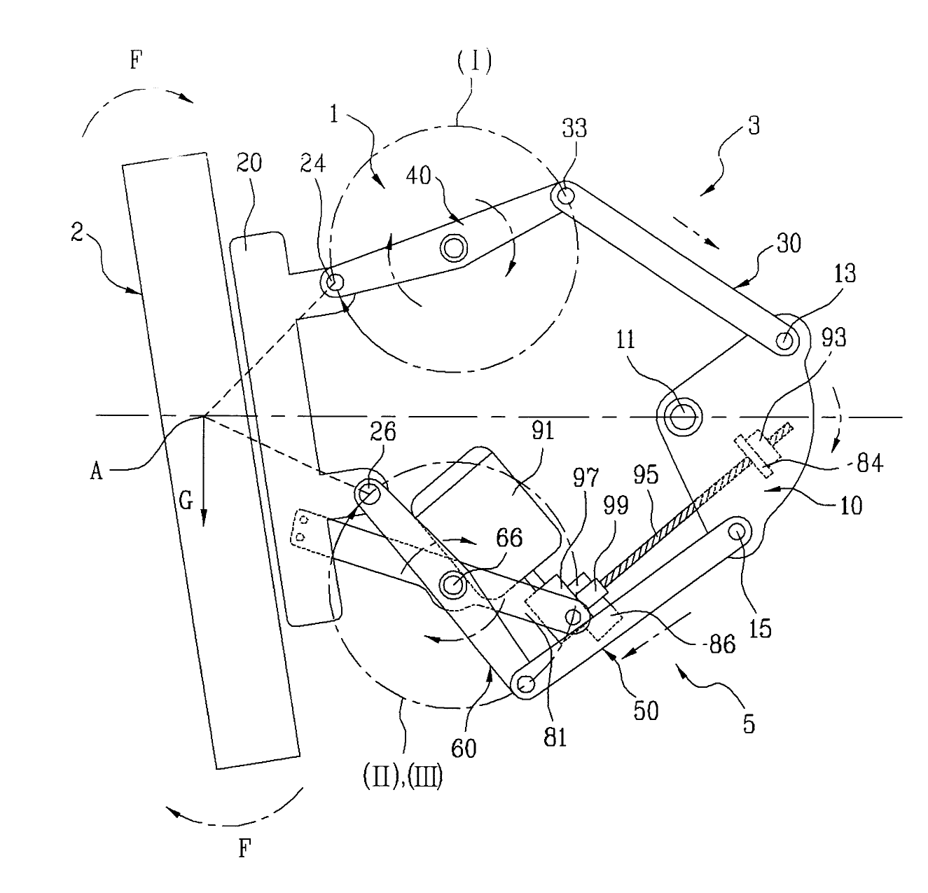

Referring to FIG. 8, if the TM screw shaft 95 is rotated in one direction by rotating the motor 91, the TM nut 93 moving straightly along the TM screw shaft 95 rotates the rotary plate 10 clockwise. Then, the upper link 30 and the upper free rotating shaft 33 move down-right, and the lower link 50 and the lower free rotating shaft 55 move down-left, and thus the upper and lower pivoting rods 40 and 60 rotate clockwise.

As described above, if the upper and lower pivoting rods 40 and 60 rotate clockwise, the upper pivoting shaft 24 installed at the other end of the upper pivoting rod 40 moves up-left along trajectory (|), and the lower pivoting shaft 26 installed at the other end of the lower pivoting rod 60 moves up-right along trajectory (∥).

Then, the upper pivoting shaft 24 moved to the left pushes the upper part of the tilting plate 20 to the left, and the lower pivoting shaft 26 moved to the right pulls the lower part of the tilting plate 20 to the right, and thus the display apparatus 2 is tilted to the left.

As described above, if the display apparatus 2 is tilted to the left, a viewing angle advantageous for a user under the display apparatus 2 to view the display apparatus 2 is secured. At this point, since the display apparatus 2 is tilted to the left, a restoration force F to rotate the display apparatus 2 to the right is generated. However, since the driving means 90 holds the rotary plate 10, the display apparatus 2 does not move any more and stays in a fixed position.

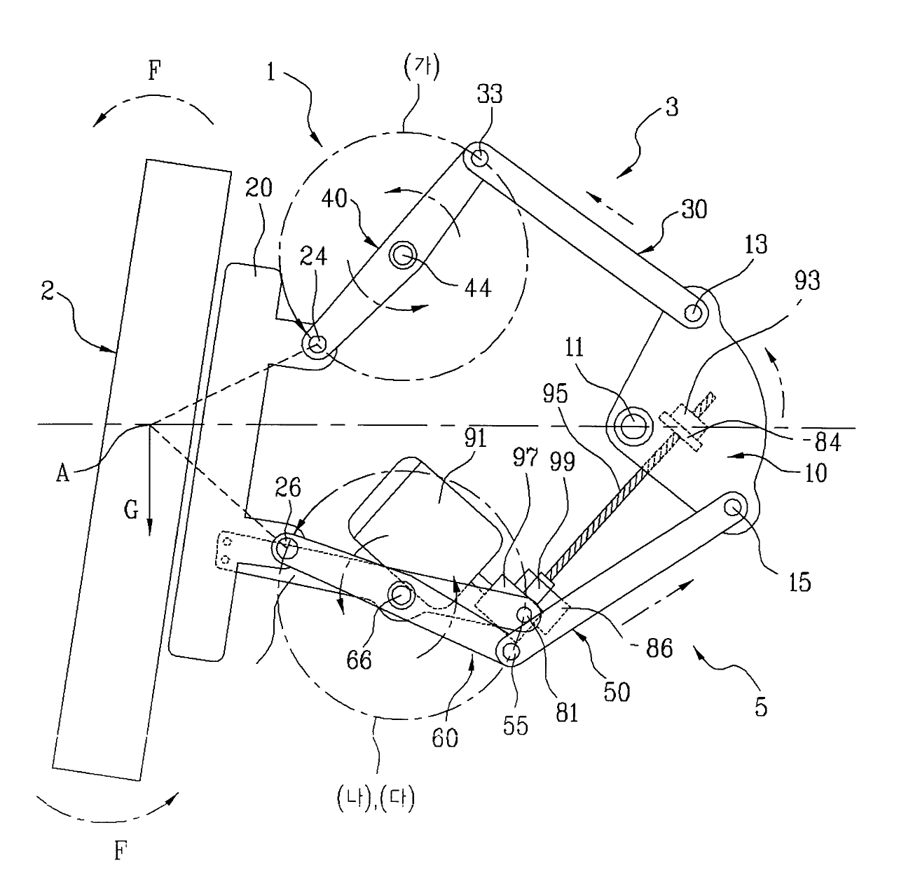

In the same manner, as shown in FIG. 9, if the TM screw shaft 95 is rotated in the other direction by rotating the motor 91, the TM nut 93 moving straightly along the TM screw shaft 95 rotates the rotary plate 10 counterclockwise. Then, the upper link 30 moves up-left to move the upper free rotating shaft up-left, and thus the upper pivoting rod 40 rotates counterclockwise. Accordingly, the upper pivoting shaft 24 connected to the upper part of the tilting plate 20 moves down-right along trajectory (|) and pulls the upper part of the tilting plate 20 to the right. At the same time, the lower link 50 moves up-right to move the lower free rotating shaft 55 up-right, and thus the lower pivoting rod 60 rotates counterclockwise. Then, the lower pivoting shaft 26 connected to the lower part of the tilting plate 20 moves down-left along trajectory (∥) and pushes the lower part of the tilting plate 20 to the left. Accordingly, the display apparatus 2 mounted on the tilting plate 20 is tilted to the right.

As described above, if the display apparatus 2 is tilted to the right, a viewing angle advantageous for a user above the display apparatus 2 to view the display apparatus 2 is secured. At this point, since the display apparatus 2 is tilted to the right, a restoration force F to rotate the display apparatus 2 to the left is generated. However, since the driving means 90 holds the rotary plate 10, the display apparatus 2 does not move any more and stays in a fixed position.

On the other hand, as shown in FIG. 8, if the display apparatus 2 is tilted to the left, the lower part of the tilting plate 20 moves to the right, and thus the supporting rod 81 fixed to the lower part of the tilting plate 20 also rotates clockwise centering on the lower fixing shaft 66, like the lower pivoting rod 60. Accordingly, the second crossbar 86 installed at the front end of the supporting rod 81 moves down-left along rotation trajectory (|∥).

On the other hand, as shown in FIG. 9, if the display apparatus 2 is tilted to the right, the lower part of the tilting plate 20 moves to the left, and thus the supporting rod 81 fixed to the lower part of the tilting plate 20 also rotates counterclockwise centering on the lower fixing shaft 66, like the lower pivoting rod 60. Accordingly, the second crossbar 86 installed at the front end of the supporting rod 81 moves up-right along rotation trajectory (|∥).

As described above, since the second crossbar 86 installed at the front end of the supporting rod 81 moves down-left or up-right depending on the rotating direction of the rotary plate 10, the rotary plate 10 can be rotated.

In addition, since the driving means 90 is installed at the second crossbar 86 pivoting upward and downward, installation space can be minimized, and configuration of the driving means 90 can be simplified.

Hereinafter, a preferred embodiment of the display tilting apparatus 1 according to the present invention will be described.

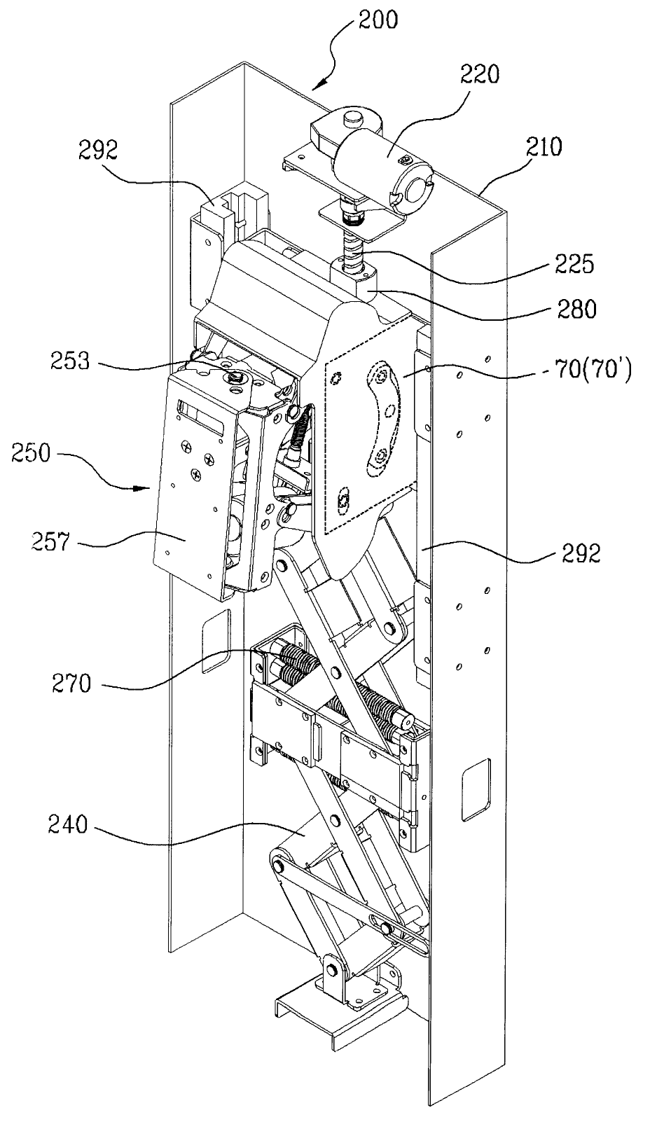

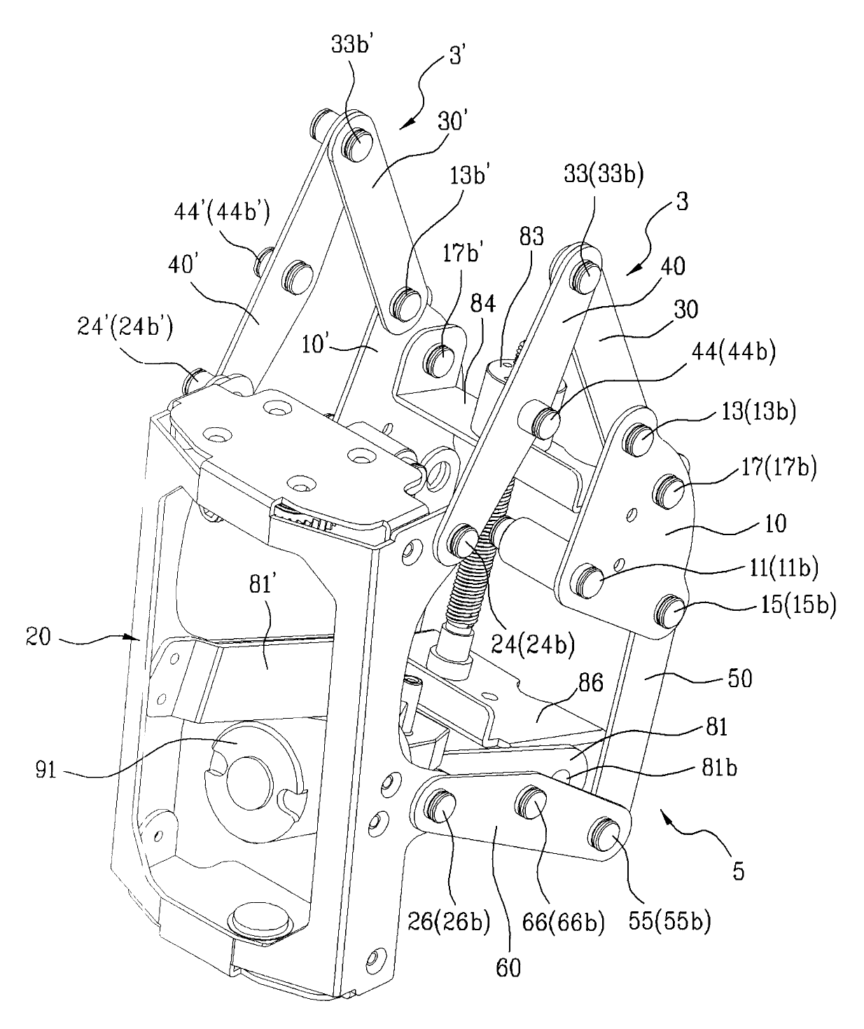

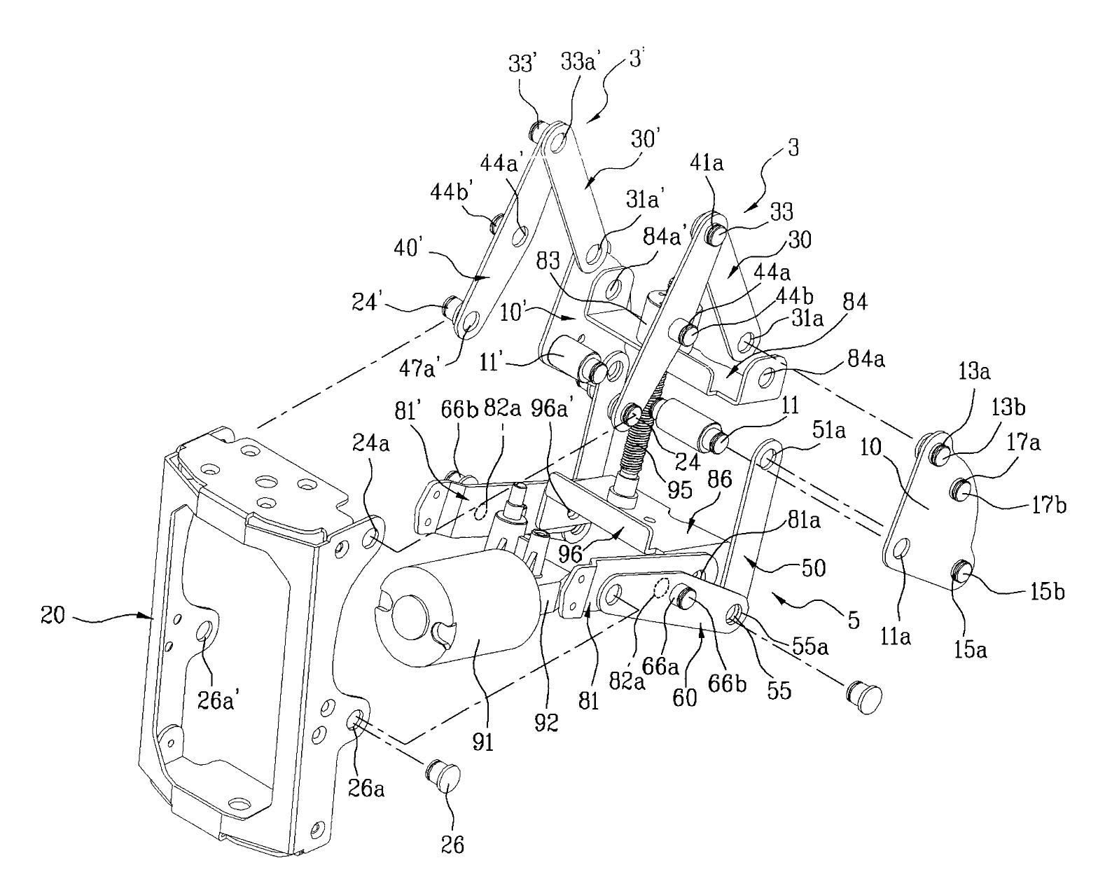

First, FIG. 10 is a perspective view showing an example of a display stand installed with a display tilting apparatus 100 according to the present invention, and FIG. 11 is a perspective view showing an example of a display tilting apparatus according to the present invention. FIG. 12 is an exploded perspective view showing the display tilting apparatus shown in FIG. 11.

First, referring to FIG. 10, the display tilting apparatus 100 according to the present invention is preferably installed on the display stand 200 that can lift the display apparatus up and down. As shown in the figure, the display stand 200 is installed to lift up and down an elevator 250 along a guide rail 292 installed at both sides of a frame 210 bent in a shape of ‘ [symbol] ’. A TM nut 280 is installed on the bottom surface of the elevator 250, and a TM screw shaft 225 passing through and screw-connected with the TM nut 280 is vertically installed at the frame 210. Accordingly, if a driving motor 220 rotates and thus the TM screw shaft 225 rotates, the TM nut 280 inserted with the TM screw shaft 225 moves up and down, and thus the elevator 250 is lifted up and down.

In addition, a foldable multi-joint body 240 of a diamond shape that can be folded and unfolded by the elevator 250 is installed at the lower portion of the frame 210. The foldable multi-joint body 240 is installed with a tension spring 270 having a repulsive force pushing upward in order to help the driving motor 220 when the elevator 250 is lifted up. The tension spring 270 is horizontally installed to hold the left and right corners of the diamond shape in order to exercise a restoration force so that the multi-joint body 240 can be prevented from being horizontally widened.

As shown in the figure, the display tilting apparatus 100 according to the present invention is installed on the elevator 250 that is lifted up and down along the guide rail 292. The elevator 250 also includes a pivoting apparatus for rotating a display apparatus to the left and right. For example, a rotating shaft 253 is installed on the top surface of the elevator 250 in order to pivot a pivoting plate 257 which is installed on the front surface of the elevator 250 so as to move to the left and right. In addition, a motor not shown in the figure for rotating the rotating shaft 253 is further provided inside the elevator 250.

Next, as shown in FIG. 10, the display tilting apparatus 100 according to the present invention installed inside the elevator 250 comprises an upper link member 3, a lower pivoting link member 5, and two fixing plates 70 and 70′ for rotatably fixing the rotary plate 10. The two fixing plates 70 and 70′ are installed to be spaced apart from each other to the left and right by a certain distance and fixed to the elevator 250 in one piece.

The configuration of a preferred embodiment of the display tilting apparatus 100 according to the present invention will be described in further detail with reference to FIGS. 11 and 12.

As shown in the figures, the display tilting apparatus 100 comprises a tilting plate 20 for installing a display apparatus, two rotary plates 10 and 10′ installed in parallel to be spaced apart from each other to the left and right by a distance almost the same as the width of the tilting plate 20, two upper link members 3 and 3′ and two lower link members 5 and 5′ rotatably installed in parallel at the upper and lower parts of the tilting plate 20 and the two rotary plates 10 and 10′, to be spaced apart from each other to the left and right by a distance almost the same as the width of the tilting plate 20, and a driving means 90 installed between the tilting plate 20 and the two rotary plates 10 and 10′ so as to simultaneously rotate the two rotary plates 10 and 10′ around an eccentric shaft 11.

Both ends of the two upper link members 3 and 3′ are rotatably installed at the upper parts of the rotary plates 10 and 10′ and the tilting plate 20, and both ends of the two lower link members 5 and 5′ are rotatably installed at the lower parts of the rotary plates 10 and 10′ and the tilting plate 20.

The two upper link members 3 and 3′ and the two lower link members 5 and 5′ have a symmetrical structure with respect to a horizontal line. That is, the upper link members 3 and 3′ are installed in a shape of ‘Λ’ centering on upper free rotating shafts 33 and 33′ and have upper pivoting rods 40 and 40′ installed toward up-right and upper links 30 and 30′ installed toward down-right. The lower link members 5 and 5′ are installed in a shape of ‘V’ centering on lower free rotating shafts 55 and 55′ and have lower pivoting rods 60 and 60′ installed toward down-right and lower links 50 and 50′ installed toward up-right.

Next, the upper pivoting rods 40 and 40′ are rotatably connected by upper pivoting shafts 24b and 24b′ passing through upper pivoting holes 24a and 24a′ formed at the tilting plate 20, and the lower pivoting rods 60 and 60′ are rotatably connected by lower) pivoting shafts 26b and 26b′ passing through lower pivoting holes 26a and 26a′ formed at the tilting plate 20.

The upper links 30 and 30′ are rotatably connected through upper rotating shafts 13b and 13b′ passing through upper holes 13a and 13a′ formed at the rotary plates 10 and 10′, and the lower links 50 and 50′ are rotatably connected through lower rotating shafts 15b and 15b′ passing through lower holes 15a and 15a′ formed at the rotary plates 10 and 10′.

The two rotary plates 10 and 10′ are rotatably fixed by a first crossbar 84 interposed between the rotary plates 10 and 10′. The first crossbar 84 is formed by bending a metal plate of a certain length in a shape of ‘ [symbol] ’, and penetrating holes 84a and 84a′ are formed at the bent portions of both sides. The first crossbar 84 is rotatably fixed to supporting holes 17a and 17a′ of the rotary plates 10 and 10′ through fixing shafts 17b and 17b′ passing through the penetrating holes 84a and 84a′.

The rotary plates 10 and 10′ are rotatably fixed to the penetrating holes 71a and 71a′ of the fixing plates 70 and 70′ by passing eccentric shafts 11b and 11b′ through eccentric holes 11a and 11a′ formed at certain parts of the rotary plates 10 and 10′.

In addition, the upper pivoting rods 40 and 40′ are rotatably fixed to the fixing plates 70 and 70′ through fixing pins 44b and 44b′ passing through upper fixing holes 44a and 44a′ formed in the middles of the upper pivoting rods 40 and 40′, and the lower pivoting rods 60 and 60′ are rotatably fixed to the fixing plates 70 and 70′ through fixing pins 66b and 66b′ passing through lower fixing holes 66a and 66a′ formed in the middles the lower pivoting rods 60 and 60′.

In addition, supporting rods 81 and 81a′ are rotatably fixed to the fixing plates 70 and 70′ through the fixing pins 66b and 66b′ passing through fixing holes 82a and 82a′ formed in the middles of the supporting rods 81 and 81a′. A second crossbar 86 is rotatably installed at penetrating holes 81a and 81a′ formed at the lower parts of the supporting rods 81 and 81a′. The second crossbar 86 is formed by bending a metal plate of a certain length in a shape of ‘ [symbol] ’, and penetrating holes 96a and 96a′ are formed at the bent portions of both sides. The second crossbar 86 is rotatably installed between the two supporting rods 81 and 81a′.

A TM screw shaft 95 is installed between the first crossbar 84 and the second crossbar 86. A bearing 99 for rotatably supporting the TM screw shaft 95 is installed at the second crossbar 86, and a TM nut 83 is installed at the first crossbar 84. In addition, a motor 91 and a power transmission module 92 for transmitting rotating power of the motor 91 are installed at the second crossbar 86.

As described above, in the display tilting apparatus 100 according to the present invention, the rotary plate 10 rotating around the eccentric shaft 11 is rotatably installed at one side of the upper and lower link members 3 and 5 which form a symmetrical structure with respect to a horizontal line, and the tilting plate 20 for mounting the display apparatus 2 is rotatably installed at the other side of the upper and lower link members 3 and 5. A rotary motion exercised at either the rotary plate 10 or the tilting plate 20 is transmitted to the rotary plate 10 or the tilting plate 20 of the other side through the upper and lower link members 3 and 5, and thus the rotary plate 10 and the tilting plate 20 keep a balanced state. Therefore, since the rotary motion of the rotary plate 10 is transmitted to the tilting plate 20 regardless of the weight of the display apparatus 2, it is possible to tilt the display apparatus 2 mounted on the tilting plate 20 using a motor of a small capacity.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A display tilting apparatus for rotating a display apparatus upward and downward, the display tilting apparatus comprising:
a rotary plate rotating upward and downward centering on one eccentric shaft;
an upper link member connected to an upper part of the rotary plate, for rotating the rotary plate;
a lower link member connected to a lower part of the rotary plate, for rotating the rotary plate;
a tilting plate rotating upward and downward, for mounting the display apparatus, in which the upper link member is connected to an upper part, and the lower link member is connected to a lower part; and
a fixing plate for rotatably supporting the eccentric shaft of the rotary plate and an upper fixing shaft and a lower fixing shaft installed in a middle of the upper link member and the lower link member.

2. The apparatus according to claim 1, wherein the upper link member and the lower link member have a symmetrical structure with respect to a horizontal line passing through the eccentric shaft of the rotary plate.

3. The apparatus according to claim 2, wherein the upper link member includes an upper pivoting rod installed at the upper part of the tilting plate toward up-right and an upper link connected to the other end of the upper pivoting rod and installed at the upper part of the rotary plate toward down-right; and
the lower link member includes a lower pivoting rod installed at the lower part of the tilting plate toward down-right and a lower link connected to the other end of the lower pivoting rod and installed at the lower part of the rotary plate toward up-right.

4. The apparatus according to claim 1 or 3, further comprising a driving means for tilting the tilting plate by rotating the rotary plate, between the upper link member and the lower link member.

5. The apparatus according to claim 4, wherein the driving means includes:
a TM nut fixed to the rotary plate;
a TM screw shaft of a certain length screw-connected with the TM nut; and
a motor for rotating the rotary plate by rotating the TM screw shaft.

6. The apparatus according to claim 5, further comprising a power transmission module for transmitting rotating power of the motor to the TM screw shaft, between a driving shaft of the motor and the TM screw shaft, wherein the driving shaft of the motor is perpendicular to the TM screw shaft.

7. The apparatus according to claim 5, wherein the TM screw shaft is installed to pass through a first crossbar rotatably installed at the rotary plate rotating around the eccentric shaft and a second crossbar rotatably installed at a front end of a supporting rod, in which the supporting rod is fixed to a rear side of the tilting plate in one piece and rotating around the lower fixing shaft rotatably installed at the fixing plate.

8. A display tilting apparatus for rotating a display apparatus upward and downward, the display tilting apparatus comprising:
two rotary plates rotating upward and downward centering on one eccentric shaft;
two upper link members connected to upper parts of the rotary plates, for rotating the rotary plates;
two lower link members connected to lower parts of the rotary plates, for rotating the rotary plates;
a tilting plate rotating upward and downward, for mounting the display apparatus, in which the two upper link members are connected to upper parts, and the two lower link members are connected to lower parts; and
two fixing plates for rotatably supporting the two eccentric shafts formed at the rotary plates and two upper fixing shafts and two lower fixing shafts installed in a middle of the upper link members and the lower link members.

9. The apparatus according to claim 8, wherein the two rotary plates are connected by a first crossbar rotatably installed between the two rotary plates.

10. The apparatus according to claim 8, wherein the two upper link members and the two lower link members have symmetrical structures with respect to horizontal lines passing through the eccentric shafts of the rotary plates.

11. The apparatus according to claim 10, wherein the two upper link members include two upper pivoting rods installed at the upper parts of the tilting plate toward up-right and two upper links connected to the other ends of the two upper pivoting rods and installed at the upper parts of the two rotary plates toward down-right; and
the two lower link members include two lower pivoting rods installed at the lower parts of the tilting plate toward down-right and two lower links connected to the other ends of the two lower pivoting rods and installed at the lower parts of the two rotary plates toward up-right.

12. The apparatus according to claim 11, wherein the two upper link members form rotation trajectory (a) by rotating around the upper fixing shafts installed at the two fixing plates, and the two lower link members form rotation trajectory (b) by rotating around the lower fixing shafts installed at the two fixing plates.

13. The apparatus according to claim 12, wherein two supporting rods rotating around the lower fixing shafts installed at the two fixing plates are formed at the lower parts of the tilting plate, and the two supporting rods form trajectory (c) by rotating around the lower fixing shafts.

14. The apparatus according to claim 12, further comprising:
a TM nut fixed to a first crossbar rotatably installed between the two rotary plates;
a TM screw shaft of a certain length screw-connected with the TM nut and rotatably passing through a second crossbar rotatably installed at front ends of the two supporting rods; and
a motor fixed to the second crossbar, for rotating the TM screw shaft.
